(19) United States
(12) Patent Application Publication
(10) Pub. No.: US 2008/0116256 A1
(43) Pub. Date: May 22, 2008

(54) System and Method for Authenticating an Object

(75) Inventors: Philippe Martin, Beaune (FR); Serge Reinaud, Marseille (FR)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: TAGSYS, a corporation of France, La Penne-sur-Huveaune (FR)

(21) Appl. No.: 11/665,554

(22) PCT Filed: Oct. 21, 2005
(86) PCT No.: PCT/FR05/02629

§ 371 Date: May 24, 2007

(30) Foreign Application Priority Data
Oct. 21, 2004 (FR) 0452389

(51) Int. Cl. G06F 19/00; G06K 7/10

(52) U.S. Cl. 235/375; 235/454

(57) ABSTRACT

A method of verifying authenticity of an object including: a) a step of filling a database of a verification server comprising: physically associating an object with an electronic tag containing unique digital identification data ID_{object}; acquiring a photograph P_{object} of the object, followed by acquiring the digital identification data ID_{object}; sending the pair (ID_{object}, P_{object}) to the verification server to be recorded in the database; and b) a subsequent step of verifying the authenticity of the object comprising: acquiring a photograph P_{product} and digital identification data ID_{product} of the product by acquisition means; sending the data P_{product} and ID_{product} to the verification server; using the verification server to compare the photograph P_{product} with the photograph P_{object} associated with the digital identification data ID_{product} equal to the digital identification data ID_{product} of the object and stored in the database.

### RELATED APPLICATION

This is a §371 of International Application No. PCT/FR2005/002629, with an international filing date of Oct. 21, 2005 (WO 2006/042980 A1, published Apr. 27, 2006), which is based on French Patent Application No. 04/52389, filed Oct. 21, 2004.

### TECHNICAL FIELD

Our technology relates to the field of electronic tags enabling contactless reading of information, which are read at a distance by a request/reading and/or writing device emitting an electrical or magnetic field.

### BACKGROUND

Express delivery companies supply a ticket with a number when they accept a parcel. This number allows them to track the parcel via the internet, from the point of acceptance to the point of delivery. However, no indication formally proves that the ticket number is actually that of the tracked parcel.

Object authentication is understood to mean positively identifying the nature or the origin of this object. In the example of a postal parcel, authentication ensures that the tracked parcel actually matches the parcel deposited in the post office and to which the tracking number is assigned.

A security control method for passengers and luggage in a transport system is known from US 2004/0098276. A photograph of the passenger is stored in a database. A boarding card containing authentication data is supplied to the passenger and RFID tags containing passenger-related data are associated with latter's luggage. When the passenger is boarding, the card is read, which displays the photo corresponding to the authentication data and this photo is visually compared with the passenger boarding.

That method does not associate the photograph with the data contained in a read RFID tag, which would make it possible, in particular, to reproduce the step at different points along a route, for postal tracking for example.

An identity verification system is also known from GB 2 391 988. The identification data (name) are associated with processed physical data (photograph) and processing information (image processing data). The association is encrypted and stored with the non-encrypted data for identification and processing information. Non-processed physical data can be subsequently processed again according to the processing information and then associated with the identification data and the processing information. They are then encrypted and compared with the previously encrypted data in order to verify the physical data.

The authentication data can be stored, among others, on an RFID chip.

In the parcel tracking example, the association of the photograph with the data contained in the RFID tag must be carried out quickly in order to allow a large number of parcels to be processed. The system described by the British patent does not enable quick processing.

A system and a method for tracking and managing articles, for example passenger luggage, is also known from U.S. Pat. No. 6,662,078. The objective in '078 is completely different to that of the disclosed technology. Indeed, '078 seeks to ensure that the holder of a piece of luggage is indeed its rightful owner. This requires processing a photograph, not of the object with which a unique identifier is associated but of people who could own several pieces of luggage.

Conversely, it could be advantageous to authenticate an object by ensuring that the analyzed object actually corresponds to what it should be (which is to say its description (its photograph) as previously recorded). It would thus be advantageous to provide a method of verifying the authenticity of an object by associating a photograph with the data contained in an electronic tag and sending the data to a verification server.

### SUMMARY

We provide a method of verifying authenticity of an object including a) a step of filling a database of a verification server including physically associating an object with an electronic tag containing unique digital identification data ID_{object}, acquiring a photograph P_{object} of the object, followed by acquiring the digital identification data ID_{object}, and sending the pair (ID_{object}, P_{object}) to the verification server to be recorded in the database; and b) a subsequent step of verifying the authenticity of the object including acquiring a photograph P_{product} and digital identification data ID_{product} of the product by acquisition means, sending the data P_{product} and ID_{product} to the verification server, and using the verification server to compare said photograph P_{product} with the photograph P_{object} associated with the digital identification data ID_{product} product equal to the digital identification data ID_{product} of the object and stored in the database.

We also provide a system for verifying authenticity of an object according to the method, including hardware that acquires a photograph and identification data (ID_{product}, P_{object}) of an object, means of sending these data (ID_{object}, P_{object}) coupled to the acquisition means and capable of sending the data to a verification server over a network, and the verification server including a database including a plurality of digital records of digital product data pairs (identification data ID_{product} and photograph P_{product}) and means of comparing the sent data (ID_{object}, P_{object}) with the data (ID_{product}, P_{product}) contained in the database.

We further provide a device for associating a photograph with identification data according to the method, including at least one control unit, one digital camera module, one electronic tag reader module and one communications module, the control unit sequentially controlling the digital camera module, then the electronic tag reader module and the communications module for sending the data recovered by the modules.

### BRIEF DESCRIPTION OF THE DRAWINGS

Our technology will be understood better from the following description, provided merely for the purpose of explanation, of representative examples in reference to the appended drawings:

FIG. 1 shows a structure of a device;

FIG. 2 shows the architecture of the system; and

FIGS. 3 and 4 are flowcharts depicting two aspects.

### DETAILED DESCRIPTION

Our methods and devices are particularly effective against counterfeiting and especially for verification and tracking (for example, of a parcel) needs by reliably associating a physical component (photograph) with identification data, and have the advantage of enabling definite authentication of an object.

To this end, we provide methods of verifying the authenticity of an object comprising the following steps:
a first prior step of filling a database of a verification server comprising steps involving:
   physically associating an object with an electronic tag containing unique digital identification data ID_{object};
   acquiring a photograph P_{object} of said object, followed by acquiring the digital identification data ID_{object};
   sending the pair (ID_{object}, P_{object}) to the verification server to be recorded in the database;
and a subsequent step of verifying the authenticity of the object, comprising steps of:
   acquiring a photograph P_{product} and digital identification data ID_{product} of the product by acquisition means;
   sending these data P_{product} and ID_{product} to the verification server; and
   using the verification server to compare the photograph P_{product} with the photograph P_{object}associated with the digital identification data ID_{product} equal to the digital identification data ID_{product} of the object and stored in the database.

The acquisition of the photograph is triggered by the user by pressing the release button of a suitable digital photography device. The acquisition of identification data is triggered by the photo acquisition, this acquisition being performed by a reading device (for example RFID) coupled to the photographic device.

Thus the object can be authenticated at any given step of a routing process since the data (photograph, identification data) are always associated.

According to various aspects:
the comparison is carried out by a human operator,
the method also comprises, after the comparison step, a step of sending a message which depends on the result of the comparison from the verification server to the acquisition means,
the acquisition means comprise a mobile terminal connected to a computer system by a wireless network, and the method comprises, after the acquisition, a step of sending the acquired data to the verification server via the computer system.

We also provide a system for verifying the authenticity of an object for implementing the method, comprising:
hardware means for acquiring a photograph and identification data (ID_{object}, P_{object}) of an object,
means of sending these data (ID_{object} P_{object}) coupled to the acquisition means and capable of sending the data to a verification server over a network,
the verification server comprising:
   a database comprising a plurality of digital records of digital product data pairs (identification data ID_{product} and photograph P_{product}),
   means of comparing the sent data (ID_{object}, P_{object}) with the data (ID_{product}, P_{product}) contained in the database.

According to various aspects:
the acquisition means comprise a digital camera, an RFID coupler and a control unit,
the sending means comprise a radio link with a computer system,
the server is capable of sending data relating to the result of the comparison over the network to the hardware acquisition means.

We also provide a device for associating a photograph with identification data comprising at least one control unit, one digital camera module, one electronic tag reader and one communications module, the control unit sequentially controlling the digital camera module then the electronic tag reader module and finally the communications module for sending the data recovered by the modules.

According to one aspect, the digital camera module is equipped with a lens including an RFID reading antenna, the antenna being connected to the reading module.

Furthermore, there are known methods for taking photographs after detecting one or more RFID tags.

These are used, for example, to photograph people at an amusement park, for surveillance and theft detection or even for identification of persons. These methods differ in the sequence of steps, since the photograph is the result of detecting one or more RFID tags.

The use of RFID (Radio Frequency Identification) tags is very widespread and enables definite identification of objects. We extend the current use of these tags by associating them with photographs for visual identification and remote verification of these data by sending information {photograph, RFID data}.

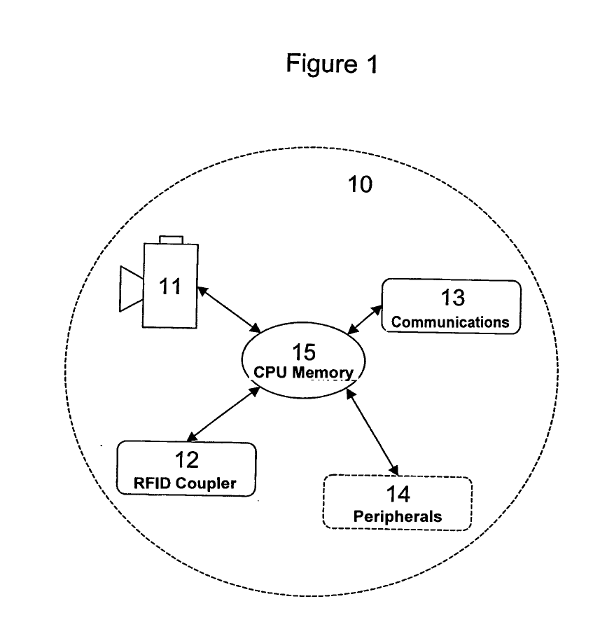

Turning now to the Drawings, FIG. 1 shows a schematic view of a complete device (10) which can be called a “mixed terminal.” The mixed terminal associates a digital camera (11) with an electronic tag querying device (12), generally an RFID coupler comprising a radio antenna, and a communications device (13). Peripherals (14), such as a printer or a display screen, can potentially be added to the mixed terminal to increase its functionality.

A control unit (15), comprising at least a processor and memory, enables exchanges between the various modules (11), (12), (13) and (14).

The querying device 12 comprises an antenna located at the end of the digital camera 11 lens and an RFID tag reader module connected to the antenna and present in a coupler. This advanced position of the detection antenna provides an optimised, precise reading of the tag affixed to the object it is facing, and therefore the photographed object.

The coupler comprises all the elements of the device other than the camera 11 and the antenna (and, potentially, certain peripherals), which is to say the RFID reader, the communications means 13 and a processing module 15 (processor, memory, logic) enabling its overall operation. The coupler can be a stand for the camera 11 and be connected to it by means of communication pins (USB connector, dedicated memory card interfacing pins, etc.).

The processing module 15 can thus recover several shot parameters from the camera 11, such as the focus, luminosity, diaphragm or shutter speed. This information can be associated with the pair (ID, photo) to reinforce its uniqueness, and thus stored in the relevant data-base(s).

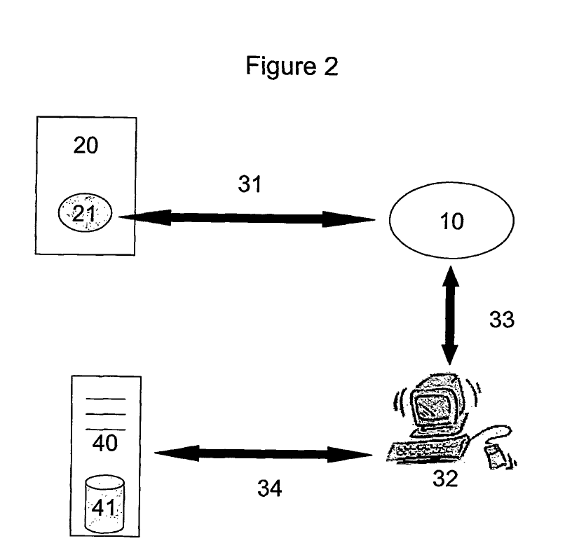

FIG. 2 shows a system. The object (20) of which the authenticity is to be verified comprises an electronic tag (21), preferably an RFID radio antenna associated with an electronic circuit so as to be queried at a short distance by a querying device comprising a radio antenna.

By means of the RFID coupler, the device (10) reads or writes data contained in the RFID tag (21) over a radio link (31). The tag can have an operating frequency of 13.56 MHz or even in the 900 MHz UHF band.

On the other hand, the device (10) is connected to a computer system (32) via a link (33). This link can be wired or wireless using networks such as GSM, UMTS, DCMA, 4D, Bluetooth, Wi-Fi (IEEE 802.11), WiMax, radiofrequency, etc. depending on the desired embodiment of the invention.

As for the computer system, it sends the data over a traditional network (34) (communications or computer, for example the Internet) to a verification server (40) comprising a database (41), for example of MySQL type.

The digital camera (11) or similar device comprises means of storing photographs such as a CompactFlash card. When the mixed terminal is activated by the user, the camera takes a photograph in a digital format such as “jpg” (Joint Photography experts Group). Almost simultaneously, although not necessarily so, the mixed terminal reads, by means of the RFID coupler, the data contained in the photographed object. “Almost simultaneous” is taken to mean with a short time lapse necessary for the control unit (15) to control the modules (11) and (12). The control unit then associates the photograph with the data read in the electronic tag. The association can be carried out simply by naming the photograph by the identifier read from the tag, or by appending a text file comprising the identifier and other complementary information to the digital “jpg” file.

Data can also be written to the RFID tag, for example for storing data such as the date and time of parcel acceptance.

To increase the security of the system, the photograph and the data read can be encrypted, compressed, etc. by computing techniques known in the state of the art.

These data are then automatically sent (managed by the control unit) to the computer system (32), generally a computer. Radio transmission can be used for short-range transmission to the system, in which case the communications device (13) is a radio transceiver.

The data (photograph, identification information) are then sent to the verification server. The object is authenticated in the server according to the sent data. The data can be stored in the database to be compared with other data sent later (postal parcel tracking) or compared with data already in the database to verify that the object exists (counterfeit searching).

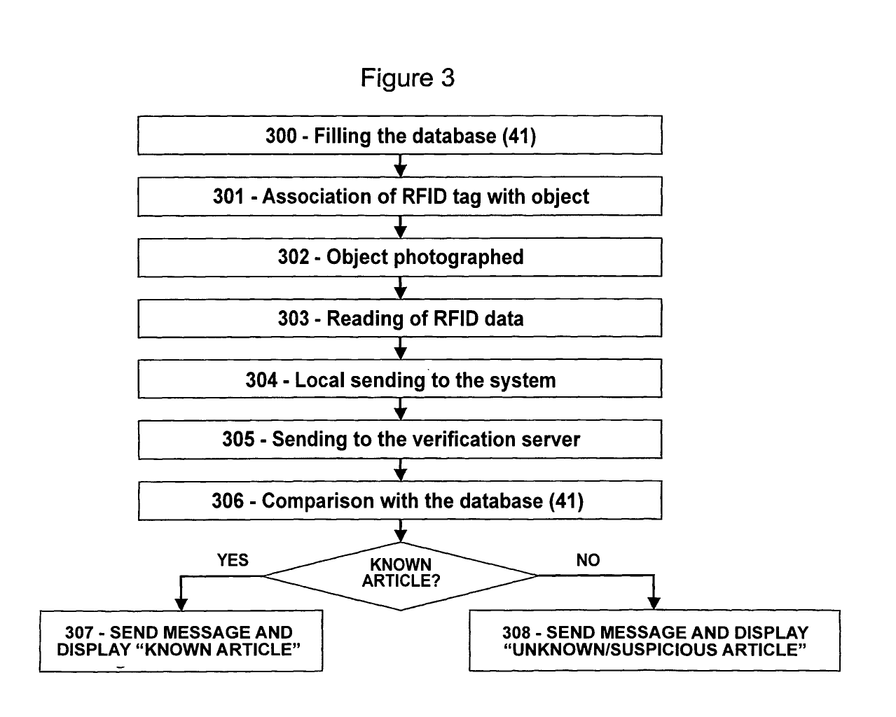

According to the flow chart shown in FIG. 3, we can detect counterfeits, for example, in the customs office.

A database (41) is previously filled with information for identification ID and description (for example a photograph) of objects (300). This step can be performed by the method on products marketed by a manufacturer.

In the customs office, the object associated with an RFID chip (301) is photographed by pressing the digital camera (302) release; the photo is then stored and the electronic system sends a message such as “Reading ID—press the release again” to the display. Once the ID (303) is read from the RFID tag by means of the RFID coupler, the ID is associated with the photo and a message such as “ready to send” is displayed. The information (ID, photo) is then sent (304) either by cable (33) to the computer (32) or by radio link (33) if the computer is not near the mixed terminal (10) or it is shared between several terminals.

The pair (ID, photo) is then sent to a processing center (305) comprising a verification server, where the database is searched to verify that the latter actually contains the ID and that it corresponds to the object of which the photo is displayed in front of the operator. Automatic means (306) of comparing the sent photo and the description information contained in the database, can also be put in place to do without an operator. For example, an image comparison algorithm in software form. The comparison of images can use complementary description data (for example, information regarding the shot) to correct the second image and be able to compare it to the first image.

Following the verification results, information is sent to the terminal by the same route and type 0 “unknown article” information displays on the terminal (308) in the case where the object and the ID have not been associated by the genuine product manufacturer.

According to another aspect for counterfeit detection, geographical position data (which thus confirm the uniqueness of its location and its possible previous movements) can be added to the preceding characteristics. This aspect applies, in particular, to works of art. For this purpose, a geographical position calculator, for example a GPS, can be added to the terminal (10). The geographical position information is then compared with that contained in the data-base.

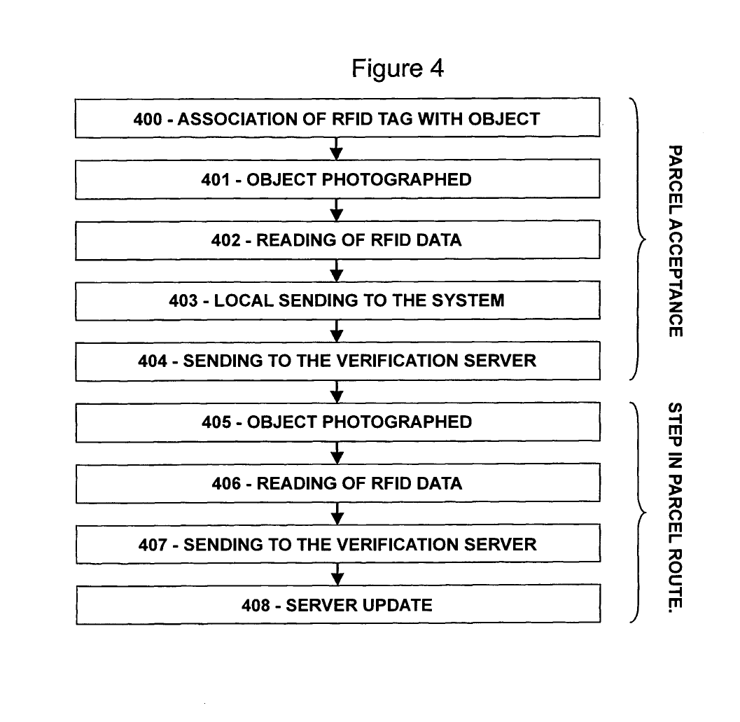

In another flow chart shown in FIG. 4, we enable tracking of postal parcels, for example.

When accepting a parcel, express delivery companies supply a ticket with a number which allows the parcel to be tracked over the internet from the acceptance location to the delivery location. There is no formal proof that the ticket number is actually that of the tracked parcel.

The terminal makes it possible, by means of a photograph, to associate the parcel with the ticket affixed to the parcel, as well as the contents of the electronic tag. This association allows the sender and the receiver to track the parcel for the duration of its route. When the parcel is received at the offices of the transport company, the ticket comprising all the data and the electronic tag is affixed to the parcel (400). A photograph is taken by the mixed terminal (401); the coupler then reads the contents of the electronic tag (402) and writes the date and the time of acceptance; this information is then sent to the computer system (403) by cable or radio link and stored in the database of the verification server (404). Complementary information regarding the acceptance location, date and time is also furnished for parcel tracking purposes. The parcel is only really accepted at this moment; a receipt containing all the information is handed over to the sender. If need be, a second photograph of the parcel can also be taken to confirm the first photograph if necessary.

The following is a simplified example of the database 41:

| Identifier | Photograph | Location | Date/time | Sender |
|---|---|---|---|---|
| 05011806140 | 6140_1.jpg | Paris (FR) | 18/01/05 | Mr. Martin |
| | | | 11:33:42 | |

Similarly, when the parcel is collected at the sender's location, the information (identifier, photograph and complementary information on time, date, sender, etc.) is taken by the terminal and sent to the computer system by the collection vehicle over a GSM telephone link, the printer being located in the same vehicle.

Then, throughout the route of the parcel (acceptance by a new distribution, sorting or storage center, etc.), a new photo is taken (405) and associated with the information contained in the RFID chip (406) and the location, date and time information. These data are sent (407) to the verification server for the purpose of updating the database (408).

| Identifier | Photograph | Location | Date/time | Sender |
|---|---|---|---|---|
| 05011806140 | 6140.jpg | Paris (FR) | 18/01/05 | Mr. Martin |
| | | | 11:33:42 | |
| 05011806140 | 6140_1.jpg | Orly (FR) | 18/01/05 | |
| | | | 18:08:23 | |

Using image comparison algorithms (contour detection and comparison, color variation in the image), the verification server compares the image 6140.jpg, already saved, with the image 6140_{—}1.jpg, just received, to warn the Orly relay center, if necessary, when parcel seems not to match the initial parcel. When the comparison is negative, a warning message (a sound beep, displaying a “Not recognised” message on the device screen) is sent to the operator terminal so that the latter can “put the parcel to one side” for subsequent verification.

This type of information is recorded at all stages of the parcel route:

| Identifier | Photograph | Location | Date/time | Sender |
|---|---|---|---|---|
| 05011806140 | 6140.jpg | Paris Louvre | 18/01/05 | Mr. Martin |
| | | (FR) | 11:33:42 | |
| 05011806140 | 6140_1.jpg | Orly Postal | 18/01/05 | |
| | | service (FR) | 18:08:23 | |
| 05011806140 | 6140_2.jpg | Barajas Postal | 19/01/05 | |
| | | Service | 00:41:20 | |
| | | (ES) | | |
| 05011806140 | 6140_3.jpg | Madrid Plaza | 19/01/05 | |
| | | Mayor (ES) | 14:05:07 | |

The addressee can also follow the parcel route “in real time”, using the photo to confirm, at each new stage, that the parcel in question is actually the initial parcel.

For increased security, the information in the electronic tag is encoded by the device coupler (10), and then sent to the computer system via the GSM telephone network and the collection vehicle.

Geographical position information (as previously mentioned) at each step of handling the package can be added to ensure efficient tracking.

In the context of an outdoor campaign, an advertiser would like to ensure that the posters are placed at the planned time and place. The supports or posters are equipped with an RFID tag and, using a mixed terminal, the panel associated with the tag data is photographed and the advertiser is sent proof that its advertising campaign has been placed as requested.

In a maintenance contract, it is desirable to ensure that the maintenance action was actually performed and listed for future actions.

A drinks vendor would like to ensure that its products are correctly positioned on the shelves of around a hundred supermarkets. Thanks to the mixed terminal, it can be directly informed of the facing operation.

Another example of application relates to car maintenance actions. The maintenance manual has a unique RFID tag. Every time a maintenance action is performed on the vehicle, an additional photograph is associated with the existing ones already stored in the database by associating this photograph with the RFID identifier of the maintenance manual tag. As a result, these data act as a guarantee for a person buying a second-hand car from an individual who therefore has proof of the maintenance performed on the car.

Thus, we supply means of authenticating the tracked parcel by means of the ticket number entered in the parcel tracking interface. This authentication is provided by associating a photograph of the parcel, clearly showing the ticket with its number and the data contained in an RFID (Radio Frequency Identification) tag stuck to the parcel.

We also thus supply a method of authenticating an object by associating a photograph with the data contained in the electronic tag of the photographed object. We also provide a device and a system enabling this association and verification of the authentication.

1-11. (canceled)

12. A method of verifying authenticity of an object comprising:
a) a step of filling a database of a verification server comprising:
physically associating an object with an electronic tag containing unique digital identification data ID_{object};
acquiring a photograph P_{object} of the object, followed by acquiring the digital identification data ID_{object};
sending the pair (ID_{object}, P_{object}) to the verification server to be recorded in the database; and
b) a subsequent step of verifying the authenticity of the object comprising:
acquiring a photograph P_{product} and digital identification data ID_{product} of the product by acquisition means;
sending the data P_{product} and ID_{product} to the verification server;
using the verification server to compare the photograph P_{product} with the photograph P_{object} associated with the digital identification data ID_{product} equal to the digital identification data ID_{product} of the object and stored in the database.

13. The method according to claim 12, wherein the comparison is carried out by a human operator.

14. The method according to claim 12, further comprising, after the comparison step, a step of sending a message which depends on the result of the comparison from the verification server to the acquisition means.

15. The method according to claim 12, wherein the acquisition means comprise a mobile terminal connected to a computer system by wireless network and, after the acquisition, a step of sending the acquired data to the verification server via the computer system.

16. A system for verifying authenticity of an object according to the method of claim 12, comprising:
hardware that acquires a photograph and identification data (ID_{object}, P_{object}) of an object,
means of sending these data (ID_{object}, P_{object}) coupled to the acquisition means and capable of sending the data to a verification server over a network,
the verification server comprising:
a database comprising a plurality of digital records of digital product data pairs (identification data ID_{product} and photograph P_{product});
means of comparing the sent data (ID_{object}, P_{object}) with data (ID_{product}, P_{product}) contained in the database.

17. The system according to claim 16, wherein the acquisition means comprise a digital camera, an RFID coupler and a control unit.

18. The system according to claim 16, wherein the sending means comprise a radio link with a computer system.

19. The system according to claim 16, wherein the server is capable of data relating to the result of the comparison over the network to the hardware acquisition means.

20. A device for associating a photograph with identification data according to the method of claim 12, comprising at least one control unit, one digital camera module, one electronic tag reader module and one communications module, the control unit sequentially controlling the digital camera module, then the electronic tag reader module and the communications module for sending the data recovered by the modules.

21. The device according to claim 20, wherein the digital camera module is equipped with a lens including an RFID reading antenna, the antenna being connected to the reading module.
